(19) United States
(12) Patent Application Publication
(10) Pub. No.: US 2003/0052926 A1
(43) Pub. Date: Mar. 20, 2003

(54) System and method for disguising depth in tree menus

(76) Inventors: Kendra L. Dunlap, Tigard, OR (US); Mark M. Josephsen, Boise, ID (US)

Correspondence Address: HEWLETT-PACKARD COMPANY, Intelectual Property Administration, P.O. Box 272400, Fort Collins, CO, 80527-2400, US

(21) Appl. No.: 09/952,953

(22) Filed: Sep. 14, 2001

(51) Int. Cl. G06F 3/14

(52) U.S. Cl. 345/841; 345/854

(57) ABSTRACT

The present invention provides a system and method for disguising the depth of tree menus via popup options. In architecture, the system includes a display device that displays a top menu, and an input device to enable a user to select an option. A graphical user interface displays a second level menu on the display device in response to the option selection, and leaves a portion of the top menu visible to the user. The present invention can also be viewed as a method for disguising the depth of tree menus. The method operates by displaying a top menu on a display device and enabling a user to select an option. A second level menu is then displayed in response to the option selection, wherein the second level menu leaves a portion of the top menu visible to the user.

### FIELD OF THE INVENTION

The present disclosure relates to systems and methods for exhibiting device functionality via menus. More particularly, the disclosure relates to systems and methods for disguising the depth of tree menus, such as through use of popup options in some embodiments.

### BACKGROUND OF THE INVENTION

Typically, printing, photocopying, faxing, and e-mailing have each been accomplished through use of separate machines. Recently, however, multi-function devices have been produced that provide the functionality of two or more of these separate machines.

Although the functionality of multi-function scanner/facsimile/copier devices provides the user with the advantage of only having to purchase and store a single machine that can be used for multiple tasks, this multiple functionality can create user interface complexity. Specifically, use of a multi-function scanner/facsimile/copier device can be complicated by the fact that the user has several different options when a document is placed in the multi-function scanner/facsimile/copier device. For instance, when a document is inserted into an automatic document feeder of the multi-function scanner/facsimile/copier device, the user may need to specify whether the document is to be copied, e-mailed, or faxed by the multi-function scanner/facsimile/copier device.

The desired functionality can be selected by the user with relative ease if the machine is a “high end” model. These models may include many different dedicated keys and/or a touch screen having many dedicated soft keys. Selection can be more difficult in the case of “lower end” machines that either do not have the display screen space or many dedicated keys due to cost considerations.

Such lower end machines are often provided with navigation keys that enable the user to select the desired functionality while navigating through a series of menus presented in a device display. Although providing the user with a method for selecting the desired functionality, the process with which the user selects this functionality can be tedious. For instance, the user may have to make many entries in the navigation menus before arriving at the desired functionality. This causes the user to traverse deep into a structured menu tree to perform the desired functionality. The structured menu tree then typically is re-traversed by the user as the user “backs out” of the menu tree. This tedious methodology can lead to increased user frustration.

From the foregoing, it can be appreciated that it would be desirable to have a system and method for simplifying the task of exhibiting device functionality via menus.

### SUMMARY OF THE INVENTION

The present disclosure relates to systems and methods for disguising the depth of tree menus. Briefly described, in architecture, a preferred embodiment of the system can include a display device that displays a top menu, and an input device that enables a user to select an option. A second level menu mechanism displays a second level menu on the display device in response to the option selection and leaves a portion of the top menu visible to the user.

The present invention can also be viewed as providing methods for disguising the depth of tree menus. In this regard, the preferred method can be broadly summarized by the following steps: (1) displaying a top menu on a display device; (2) enabling a user to select an option; and (3) displaying a second level menu in response to the option selection, where the second level menu leaves at least a portion of the top menu visible to the user.

The features and advantages of the invention will become apparent upon reading the following specification when taken in conjunction with the accompanying drawings.

### BRIEF DESCRIPTION OF THE DRAWINGS

The invention can be better understood with reference to the following drawings. The components in the drawings are not necessarily to scale; emphasis is being placed upon clearly illustrating the principles of the present invention.

FIG. 1 is a schematic diagram illustrating an example of the environment for a multi-function device that can utilize the graphical user interface (GUI) system of the present invention.

FIG. 2A is a block diagram illustrating an example of the multi-function device including the GUI system of the present invention.

FIG. 2B is a schematic diagram illustrating an example control panel of the multi-function device, as shown in FIGS. 1 and 2A.

FIG. 3A is a flow chart illustrating preferred functionality of an example of the GUI system of the present invention utilized by multi-function devices, such as a scanner/facsimile/copier, as shown in FIGS. 1 and 2A.

FIG. 3B is a flow chart illustrating preferred functionality of an example of the describe original document process utilized by the GUI system of the present invention, as shown in FIG. 3A.

FIG. 4 is a flow chart illustrating preferred functionality of an example of the send process utilized by the GUI system of the present invention, as shown in FIGS. 2A and 3.

Illustrated in FIG. 5 is a flow chart illustrating preferred functionality of an example of the login process utilized by the GUI system of the present invention, as shown in FIGS. 2A and 3.

FIG. 6 is a flow chart illustrating preferred functionality of an example of the folder process utilized by the GUI system of the present invention, as shown in FIGS. 2A and 3.

FIG. 7A is a flow chart illustrating preferred functionality of an example of the e-mail process utilized by the GUI system of the present invention, as shown in FIGS. 2A and 3.

FIG. 7B is a flow chart illustrating preferred functionality of an example of the e-mail setting process utilized by the e-mail process, as shown in FIG. 7A.

FIG. 8A is a flow chart illustrating preferred functionality of an example of the fax process utilized by the GUI system of the present invention, as shown in FIGS. 2A and 3.

FIG. 8B is a flow chart illustrating preferred functionality of an example of the fax setting process utilized by the fax process, as shown in FIG. 8A.

FIG. 9A is a flow chart illustrating preferred functionality of an example of the copier process utilized by the GUI system of the present invention, as illustrated in FIGS. 2A and 3.

FIG. 9B is a flow chart illustrating preferred functionality of an example of the copy document setting process utilized by the copier process, as shown in FIG. 9A.

FIGS. 10A through 10E are block diagrams illustrating examples of the original document setting menu displays utilized by the GUI system of the present invention, as shown in FIGS. 2A and 3.

FIGS. 11A through 11C are block diagrams illustrating examples of the logon menu displays utilized by the GUI system of the present invention, as illustrated in FIGS. 2A and 3.

FIGS. 12A through 12G are block diagrams illustrating examples of the e-mail menu displays created by the GUI system of the present invention, as shown in FIGS. 2A and 3.

FIGS. 13A through 13D are block diagrams illustrating examples of the facsimile menu displays utilized by the GUI system of the present invention, as illustrated in FIGS. 2A and 3.

FIGS. 14A through 14G are block diagrams illustrating examples of the copier menu displays utilized by the GUI system of the present invention, as illustrated in FIGS. 2A and 3.

### DETAILED DESCRIPTION

Referring now in more detail to the drawings, in which like numerals indicate corresponding parts throughout the several views, the present invention will be described. While the invention is described in connection with these drawings, there is no intent to limit it to the embodiment or embodiments disclosed therein. On the contrary, the intent is to cover all alternatives, modifications, and equivalents included within the spirit and scope of the invention as defined by the appended claims.

The present invention relates to menu depth traversal within structured menu trees. Preferred embodiments of the GUI system of the present invention utilize overlapping pop-up option menus in order to disguise the depth in the tree structure menu traversal. By utilizing this technique, second level menus, which can use an overlapping pop-up box, leave a portion of the underlying menu in view. Therefore, the user does not perceive that they have traveled far down the menu tree when making their required option selections. By utilizing the pop-up option menus to disguise the depth in the tree structured menu traversal, user satisfaction has been significantly improved, as compared to using hard key navigation with a limited menu display capability, for example.

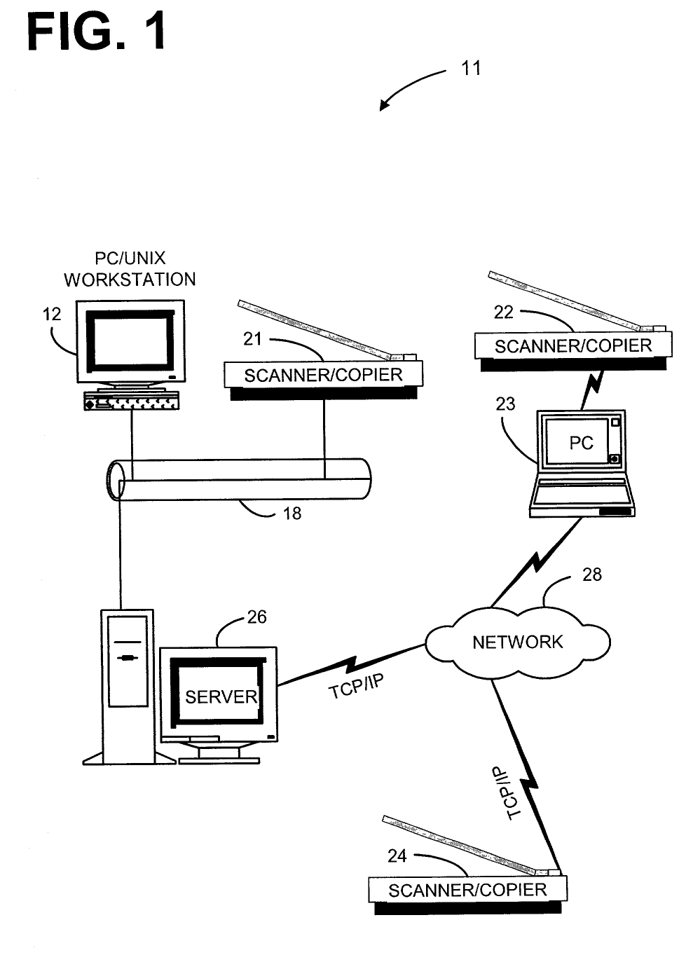

Turning now to the drawings, FIG. 1 is a block diagram of possible system configurations that illustrate the flexibility and platform independence of the present invention. The multi-function devices, such as the scanner/facsimile/copier devices 21, 22 and 24, are provided for illustration purposes only and could be provided in various forms. The scanner/facsimile/copier devices 21, 22 and 24 are hereafter referred to as multi-function devices 21, 22 and 24. The diagram of FIG. 1 illustrates a plurality of multi-function devices 21, 22 and 24 that use the GUI system of the present invention, which disguises the depth in tree menus, such as via pop-up menus. Each of the multi-function devices 21, 22 and 24 in FIG. 1 are uniquely illustrated to emphasize that multi-function devices may comprise diverse hardware platforms.

As can be seen in FIG. 1, the multi-function devices 21, 22 and 24, may be connected to a local network 18, computer 21 and/or to a network 28. A stand-alone multi-function device 21 may be directly connected to a server 26 via a communication link 18. Network 18 may be, for example, an Ethernet type network (e.g., 10 BASE 2, 10 BASE 5, 10 BSAF, 10 BASE-T, base band network, a coaxial cable, a dial-in, LAN, WAN, PSTN, Intranet and Internet. The multi-function device 22 may also be supported by a computer 23. This enables the computer 23 to directly control the multi-function device 22. The multi-function device 24 may also be directly connected to a network 28 to provide stand-alone capability. The network 28 may be for example, but not limited to, a dial-in, LAN, WAN, PSTN, Intranet and Internet communication links.

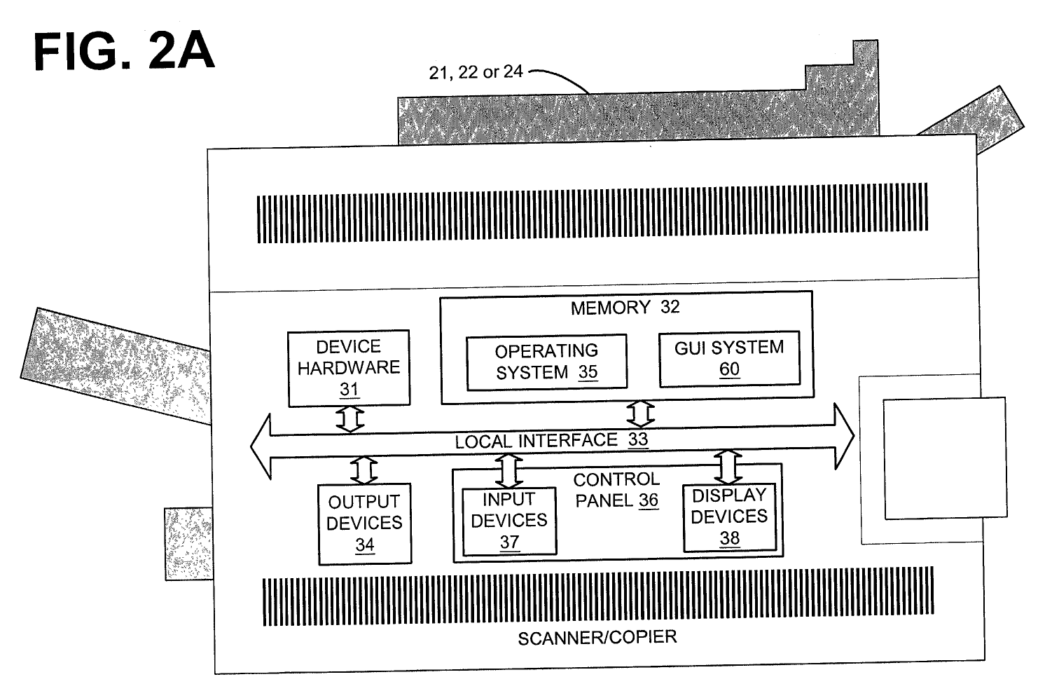

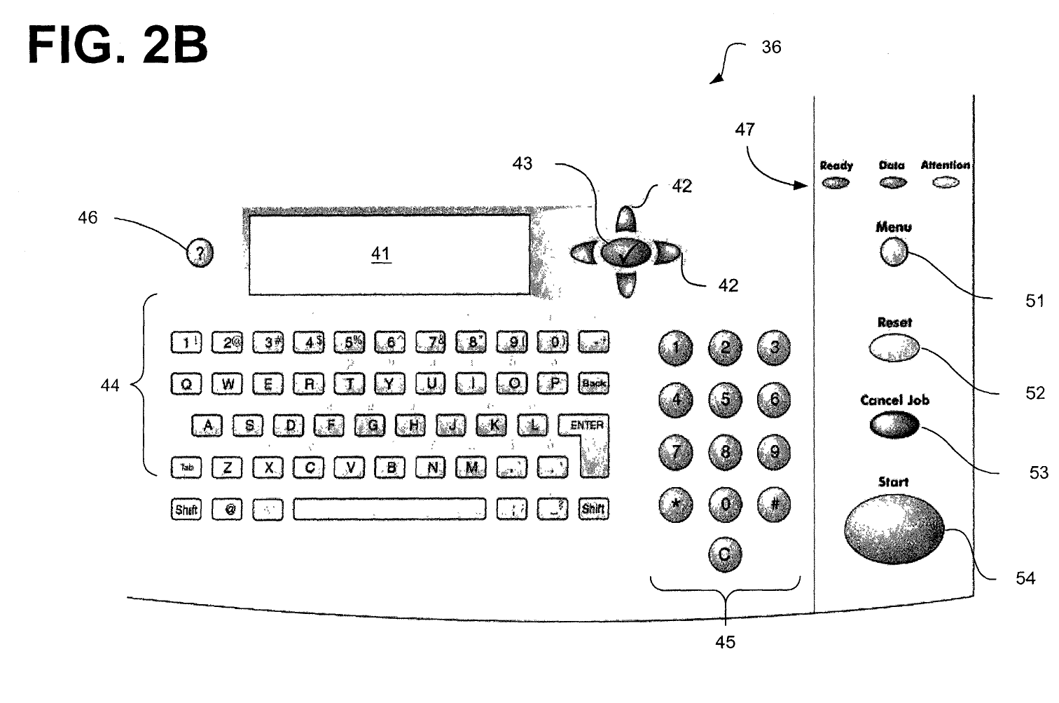

FIG. 2A is a schematic illustrating an example architecture for the multi-function devices 21, 22 and 24 shown in FIG. 1. As will be further discussed in FIG. 2A, the multi-function devices 21, 22 and 24 comprises device hardware 31, input devices 37, output devices 34, display devices 38, and memory 32. The memory 32 stores software and/or firmware that controls operation of the multi-function devices 21, 22 and 24, and a local interface 33 (e.g., internal bus) to which each of the other identified components electrically connect. The input devices 37 and display devices 38 are illustrated together on control panel 36 for the purposes of discussion of the GUI system 60 of the present invention that disguises the depth in tree menus. It is contemplated that the input device 37 and display devices 38 can reside on separate control panels.

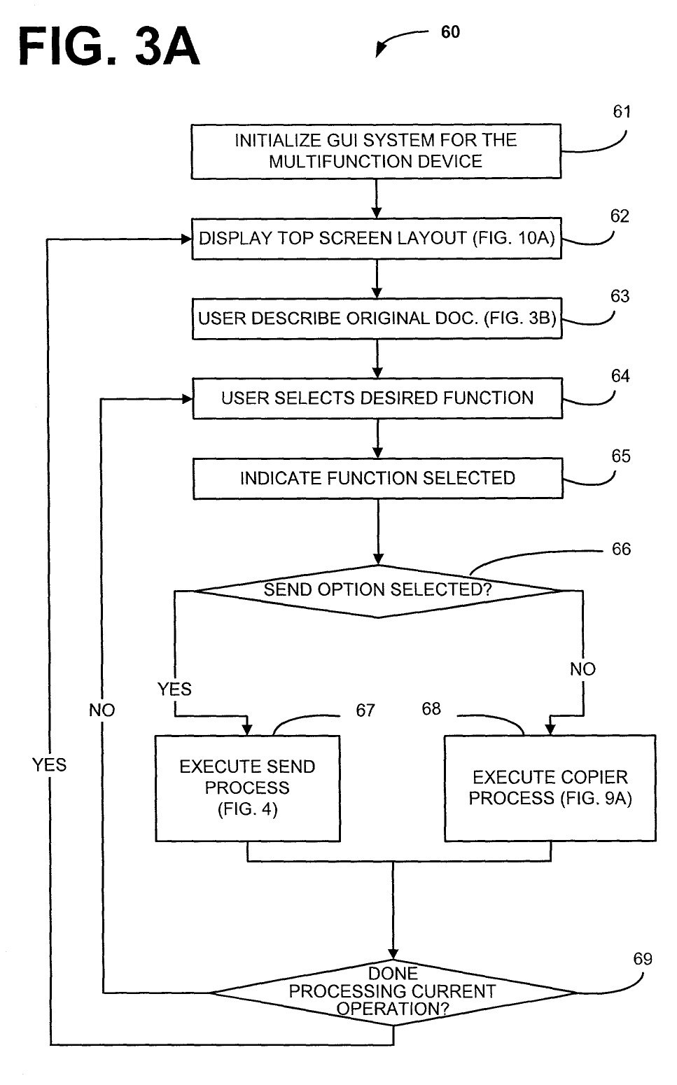

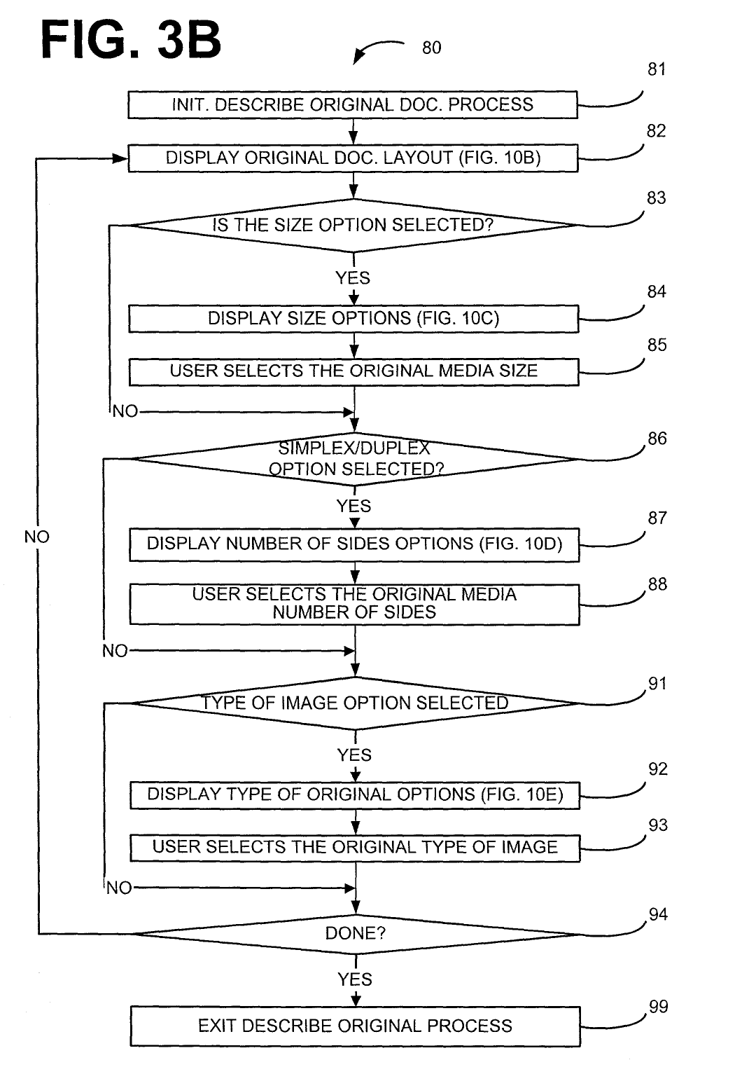

The device hardware 31 includes the various electrical components used in performing the various functions of the multi-function scanner/facsimile/copier device 21, 22 and 24. For instance, these components can include the mechanisms necessary for processing the operating system 35 control instructions that enable the printing, photocopying, e-mailing, and faxing by the multi-function device 21, 22 and 24. As identified in FIG. 2A, the memory 32 comprises operating system 35, which contains the various execution commands necessary to control the device mechanisms and their operation. In addition, the memory 32 includes GUI system 60 that is adapted to control the multi-function devices 21, 22 and 24, and assists the user to control the device through the use of a menu system that disguises the depth in the tree menus. The GUI system 60 is herein defined in further detail with regard to FIG. 3.

The operating system 37 and the GUI system 60 each can be implemented in software, firmware, or a combination thereof. The GUI system 60 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system apparatus, or device.

The computer readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed. The program can be electronically captured via, for instance, optical scanning of the paper or other medium, then compiled, interpreted or otherwise processed in a suitable manner if necessary, and then stored in a computer memory.

The output devices 34 typically include interface elements for transmitting electronic information from the multi-function devices 21, 22 and 24, to other devices that are connected to the device. For instance, these interface elements can include components adapted to send data via e-mail or fax to a computing device and fax machine, respectively. In addition, where the multi-function devices 21, 22 and 24 include printing functionality, the output devices 35 can include the various printing components necessary to output hardcopy documents when the device is used as a printer or photocopying machine.

The input devices 37 typically comprise user interface elements such as a keyboard, numeric keypad, and various buttons with which a user can input various commands and settings. The keyboard, numeric keypad, and various buttons are herein defined in further detail with regard to FIG. 2B. In addition, the input devices 37 can include interface elements for receiving electronic information from, by way of example, a computing device 23 (FIG. 1). The multi-function devices 21, 22 and 24 is adapted for printing, and various components used to transform hardcopy document into electronic form such as a platen, automatic document feeder, and document scanner.

The display device 38 normally comprises a display screen as well as indicator lights that convey various information to the user. Where the display devices include a display screen, the display screen can comprise, for example, but is not limited to, a liquid crystal display (LCD), a touch sensitive screen, and a combination of both or like devices. If indicator lights are provided, these lights can comprise individual light emitting diodes (LEDs) or other light-emitting elements. The display screen is herein defined in further detail with regard to example control panel 36 discussed with regard to FIG. 2B.

FIG. 2B illustrates an example control panel 36 of the multi-function scanner/facsimile/copier device 21 that can be used to facilitate user interface with the device. As identified in this figure, the control panel 36 normally includes a display 41 with which information can be presented to the user and with which commands can be communicated to the multi-function devices 21, 22 and 24. To lower the cost of the multi-function devices 21, 22 and 24, the display 41 preferably comprises an LCD that does not possess touch screen functionality.

In addition to the display 41, the control panel 36 can include a keyboard 44 with which the user can enter various alphabetic and numeric characters. By way of example, this keyboard 44 typically is a QWERTY type keyboard, although other keyboard styles would also be suitable. In addition to the keyboard 44 is a numeric keypad 45 with which the user can enter numeric characters. As identified in FIG. 2B, the numeric keypad 45 is normally arranged in similar manner to that found on conventional push-button telephones. As will be discussed below, this arrangement aids the user in entering phone numbers when fax functionality is desired.

In addition to the keyboard 44 and numeric keypad 45, the control panel 36 normally further includes a help button 46 with which the user can access tutorial information. This tutorial information is presented with the display 41, a series of directional keys 42 with which the user can navigate various menus presented via the display, and a select button 43 with which the user can select an item from one of these menus. The control panel 36 can additionally include a menu button 51, a reset button 52, a cancel job button 53, and a start button 54.

The menu button 51 can be used to access the various menus that are presented to the user with the display 41. The reset button 52 resets the multi-function devices 21, 22 and 24 after information has been entered by the user or various selections made. The cancel job button 53 is used to cancel a task that the multi-function devices 21, 22 and 24 has begun to execute (e.g., a print job, a photocopy job, an e-mail job, or a fax job). Finally, the start button 54 is used to initiate a task to be performed by the multi-function devices 21, 22 and 24. In addition to buttons, the control panel 36 can further include indicator lights 47 that identify the operational status of the multi-function devices 21, 22 and 24. For instance, the indicator lights 47 can indicate that the multi-function devices 21, 22 and 24 is ready, for receiving and/or sending data, is experiencing a problem that calls for the user's attention.

FIG. 3A is a flow chart that illustrates functionality of an example of the GUI system 60 (FIG. 2A) for a multi-function devices 21, 22 and 24 that disguises the depth in tree menus via pop-up menus. The GUI system 60 controls the menu system in which a user may select functionality of a multi-function devices 21, 22 and 24.

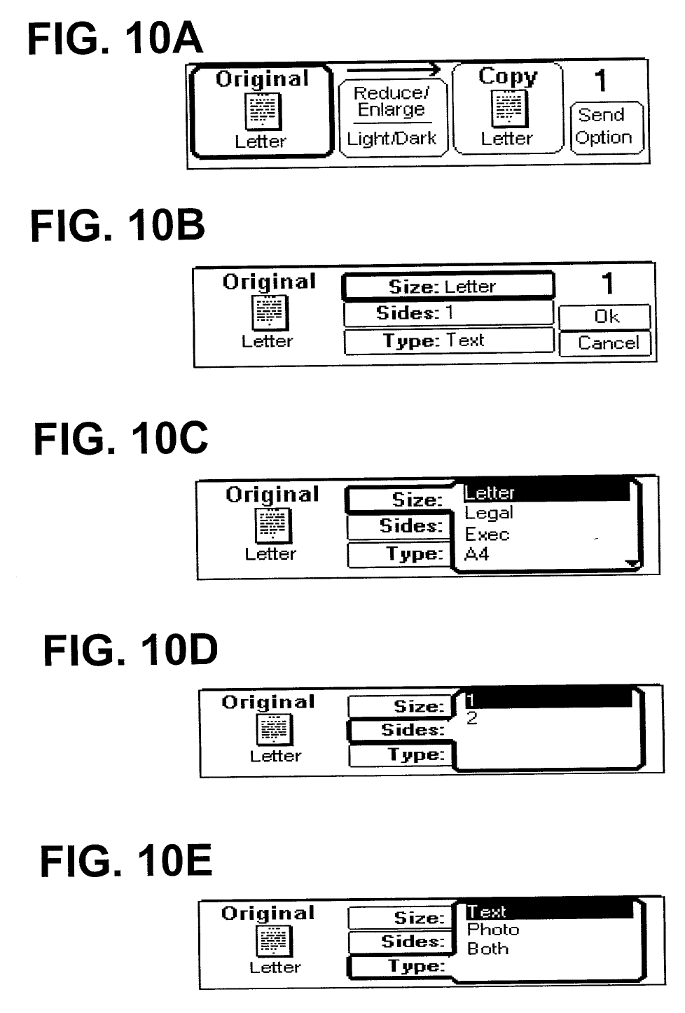

First, the GUI system 60 that disguises the depth in a tree-structured menu via popup menu options is initialized at step 61. Next at step 62, the GUI system 60 displays a top screen layout on the display 41. An example of the top screen layout is herein disclosed in FIG. 10A. The example of the stop screen layout illustrates the multi-function capability of defining a document modifying the characteristics of the document, copying the document and enabling the sending of the document. At step 63, the user then describes the original document set-up using a describe original document process. The describe original document process is herein defined in further detail with regard to FIG. 3B.

At step 64, the user selects the desired function for the multi-function devices 21, 22 and 24 through input into the GUI system 60. At step 65, the multi-function devices 21, 22 and 24 indicate the function selected on display 41 (FIG. 2B). This indication of which function is selected can be, but is not limited to, providing a bold border around the graphical screen button, or a reverse video effect on the textual list in the function button to indicate the function selected.

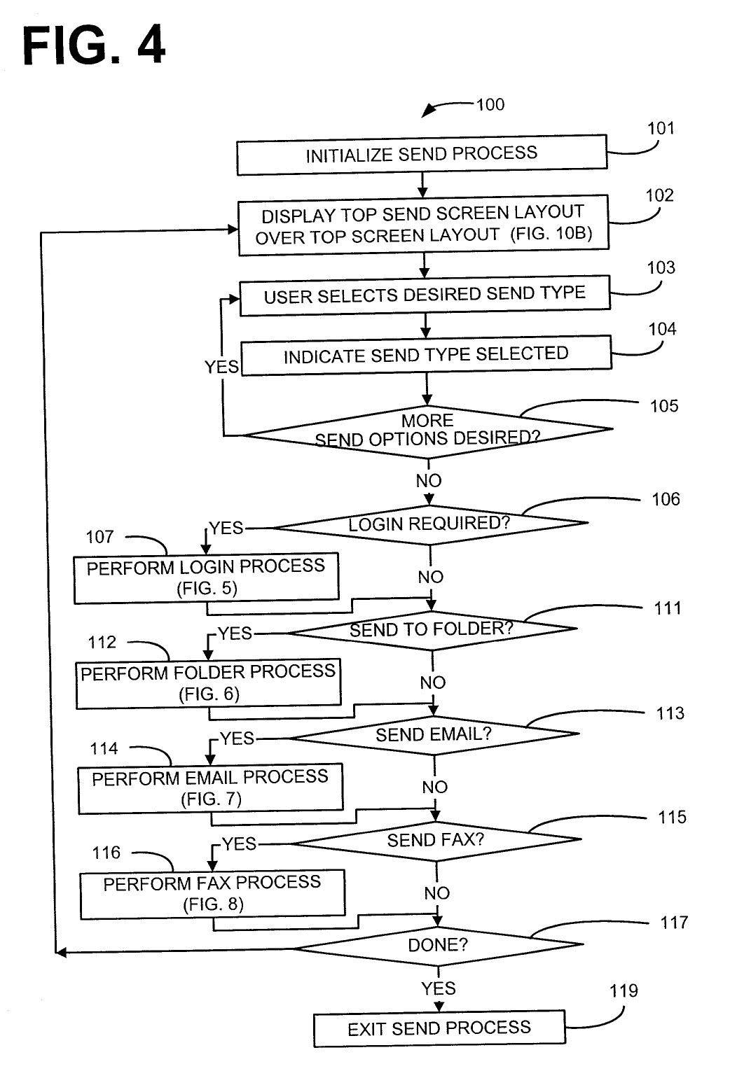

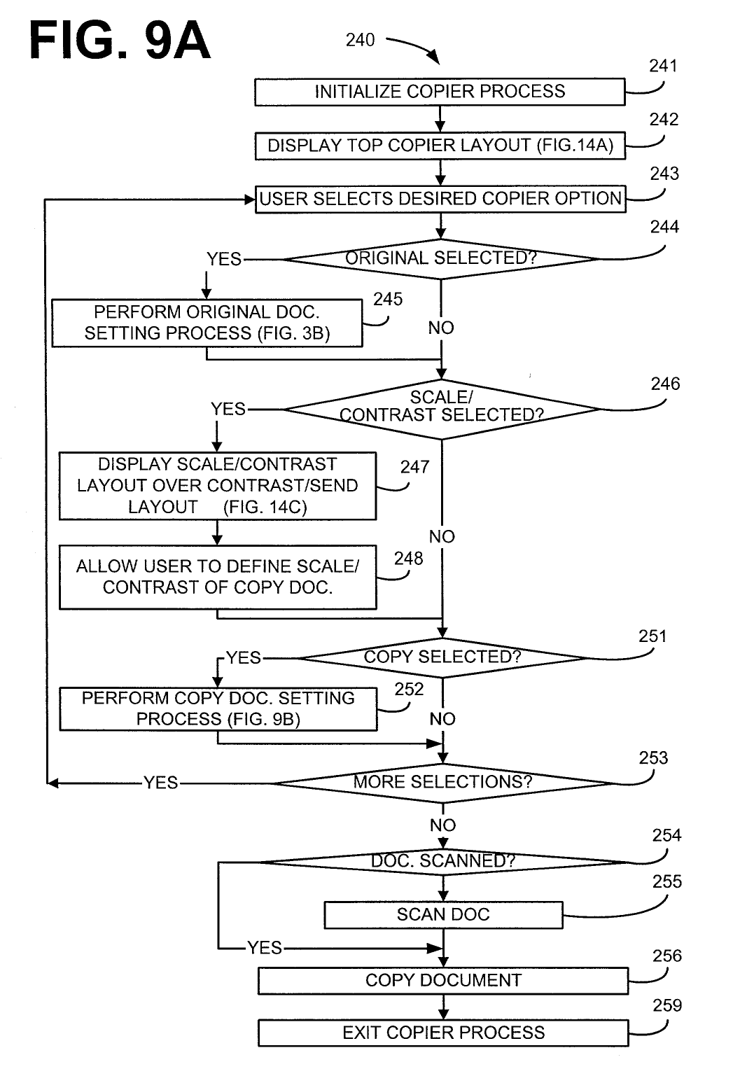

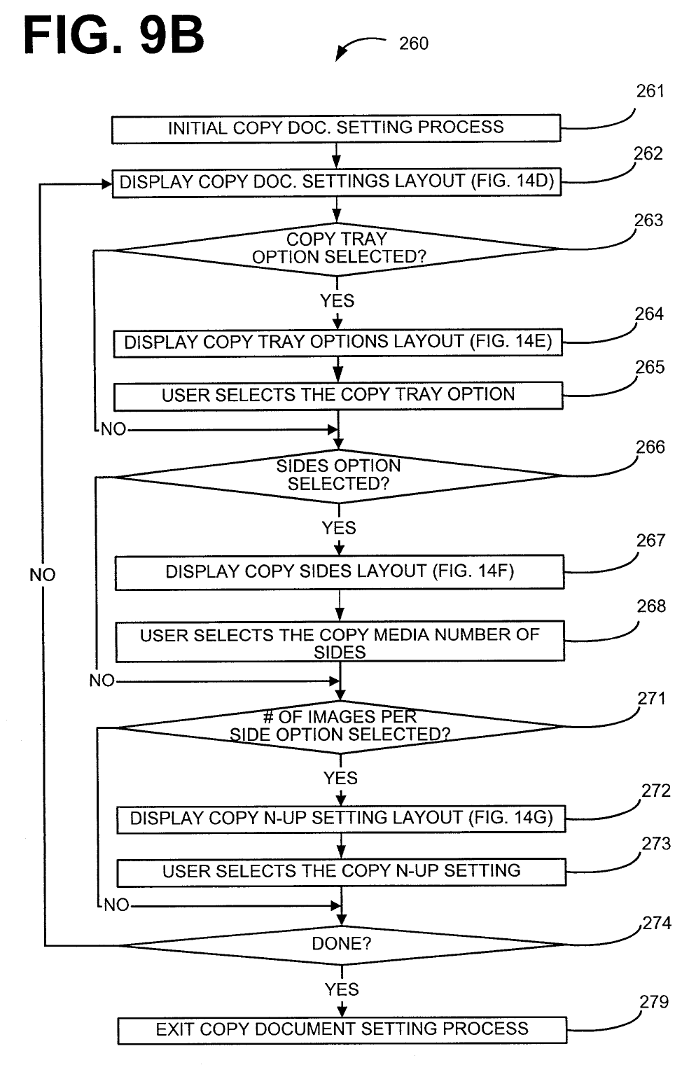

At step 66, the GUI system 60 then determines whether a send option was selected. If it is determined at step 66 that a send option was selected, the GUI system 60 then proceeds to step 67 and executes the send process. The send process is herein defined in further detail with regard to FIGS. 4-8. After performing the send function, the GUI system 60 then proceeds to step 69. However, if it is determined at step 66 that the user has not selected the send function, the GUI system 60 then proceeds to step 68 to execute the copier process. The copier process is herein defined in further detail with regard to FIG. 9A. After performing the selected copier process at step 107, the GUI system 60 then proceeds to step 69.

At step 69, the GUI system 60 then determines whether multi-function scanner/copiers 21, 22 and 24 is done processing the current operation. If it is determined at step 69 that the GUI system 60 is not done processing the current operation, the GUI system 60 then proceeds to repeat steps 64 through 69. However, if it is determined at step 69 that the GUI system 60 is done processing the current operation, the GUI system 60 then returns to display the top screen layout at step 62, for further processing.

Illustrated in FIG. 3B is a flow chart depicting functionality of an example of the describe original document process 80 utilized by the GUI system 60 of the present invention. The describe original document process 80 enables a user to describe the configuration of the original document to be processed. First, the describe original document process 80 is initialized at step 81. At step 82, the display original document layout is displayed on display 41 (FIG. 2B). An example of the original document layout is illustrated in FIG. 10B. As illustrated in the example, the original document layout includes, but is not limited to, the ability to define the size, sides and type characteristics of the original document.

Next, the describe original document process 80 determines whether the scale option is selected. If it is determined at step 83 that the scale option is not selected, the describe original document process 80 then skips to step 86. However, if it is determined at step 83 that the scale option was selected, the describe original document process 80 then displays the original scale option at step 84. An example of the pop-up menu that displays the scale options is illustrated in FIG. 10C. As illustrated in the example, the scale options include, but are not limited to, letter size, legal size, executive and A4 sizes in the pop-up menu depicted by the bold outline. As can be seen, the pop-up menu is displayed over a portion of the original document top screen menu. The menu overlapping disguises the depth in tree structure menu traversal. At step 85, the user inputs the original media size utilizing the scale option screen layout displayed at step 84.

At step 86, the describe original document process 80 then determines whether the simplex or duplex option has been selected. If it is determined at step 86 that the simplex or duplex option has not been selected, the describe original document process 80 then proceeds to step 91. However, if it is determined at step 86 that the simplex or duplex option was selected, the describe original document process 80 then displays the number of side options at step 87. An example of the pop-up menu that displays the number of sides is illustrated in FIG. 10D. In this example, the pop-up menu is depicted by the bold outline that illustrates the number of sides for the original document. At step 88, the describe original document 80 then allows the user to select the original media number of sides.

At step 91, the describe original document process 80 then determines whether the type of image option was selected. If it is determined at step 91 that the type of image option was not selected, the describe original document process 80 then skips to step 94. However, if it is determined at step 91 that the type of image option was selected, the describe original document process 80 then displays the original document option at step 92. An example of the pop-up menu that displays the type of original options is herein displayed in FIG. 10E. The pop-up menu that displays the type of original options is illustrated in bold and includes, but is not limited to, text, photo, and both types for the description of the original document. As shown, the originals options are depicted in bold and are displayed over a portion of the original document top screen menu. At step 93, the describe original document process 80 allows the user to select the original type of document.

At step 94, the describe original document process 80 determines whether the user is finished describing the original document. If it is determined at step 94 that the user is not done describing the original document, the describe original document process 80 then returns to repeat step 82 through 93. However, if it is determined at step 94 that the user is finished describing the original document, the describe original document process then exits at step 99.

Illustrated in FIG. 4 is a flow chart depicting the functionality of an example of the send process 100 utilized by the GUI system 60 of the present invention. The user has, but is not limited to, the choices of sending an e-mail, fax or sending a document to a folder. When an option is selected, a new screen or screens will be displayed to allow the user to specify the particulars of the send option. Once a send option has been selected and specified, the send option box will be checked. If the option is pressed again, the check will be removed and the option will become inactive. However, the specification set up for that option is not lost. Pressing the option once again will take the user to the option set up screen or screens with the previous specifications attached. The send process 100 utilized by the GUI system 60 of the present invention will now be described.

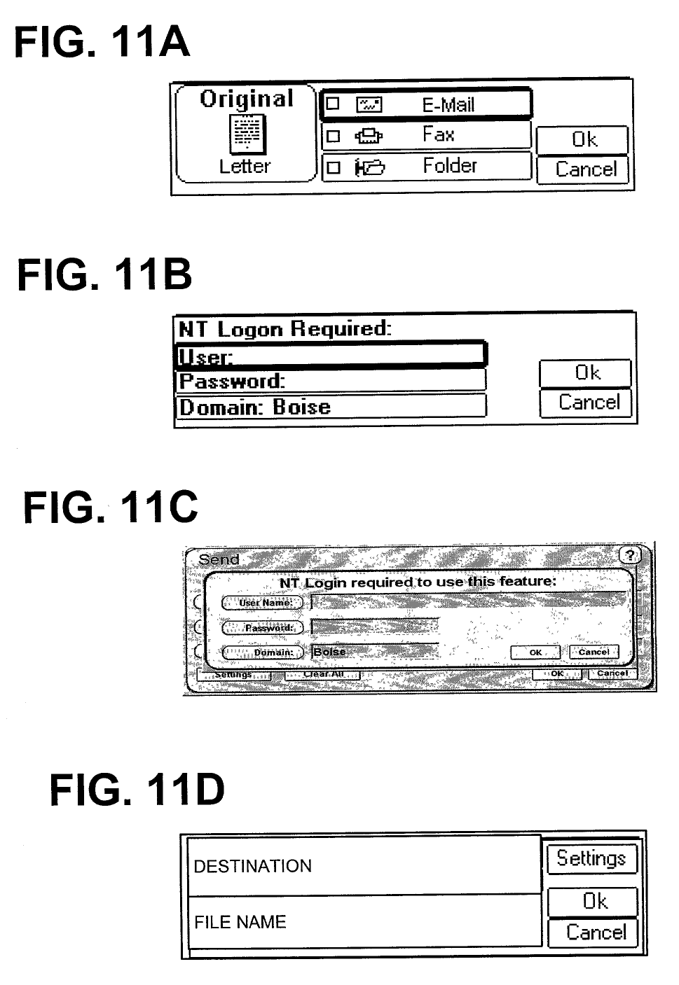

First, the send process 100 is initialized at step 101. At step 102, the send process 100 displays the top send screen layout over the top screen layout to indicate that the send functionality was selected. An example of the top send screen layout is illustrated in FIG. 11A and as previously described above. Next, at step 103, the send process 100 allows the user to select the desired send type. At step 104, the send process 100 then indicates the type selected.

At step 105, the send process 100 then determines whether there are more send options that the user desires to have indicated. If it is determined at step 105 that more send options are desired, the send process 100 then returns to repeat steps 103 through 105. This option will enable a user to select multiple send options at the same time. For example, the user will be able to send a document by e-mail and by fax to different destinations in the same procedure.

If it is determined at step 105 that the user does not desire to select or send options, the send process 100 then determines at step 106 whether or not the user is required to log in. Logging in is required if authentication for the system is enabled. If authentication is enabled, then the first time a user presses one of the send options, they must perform the login process. The send process 100 performs the login process at step 107. The login process is herein defined in further detail with regard to FIG. 5.

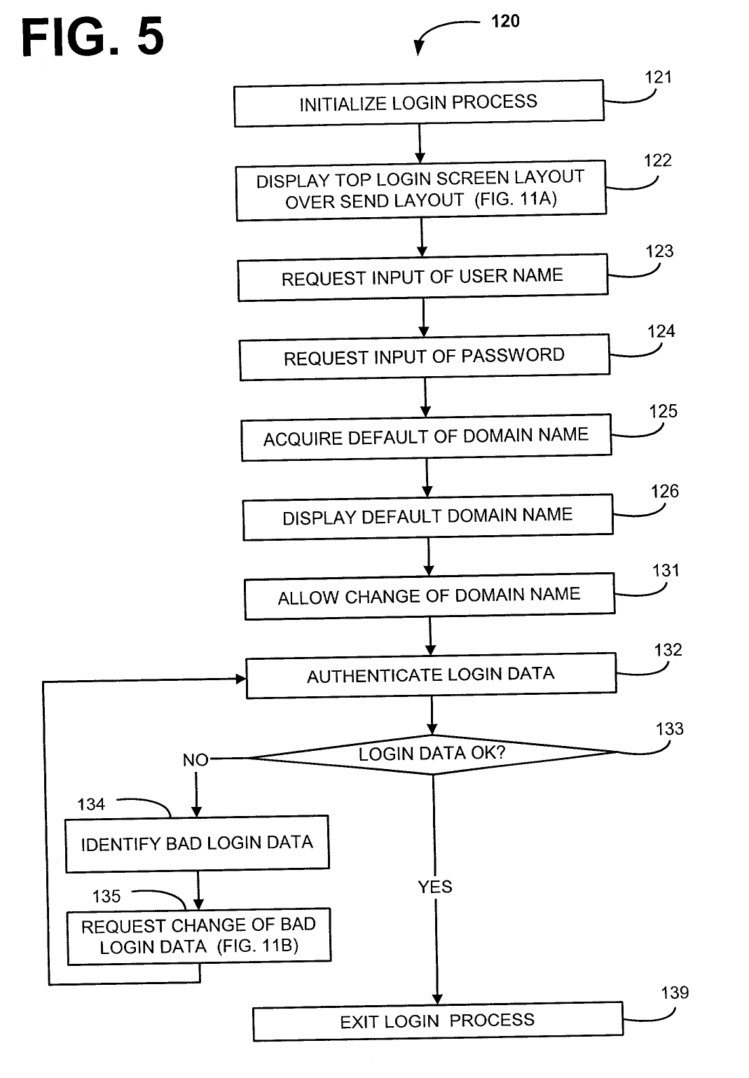

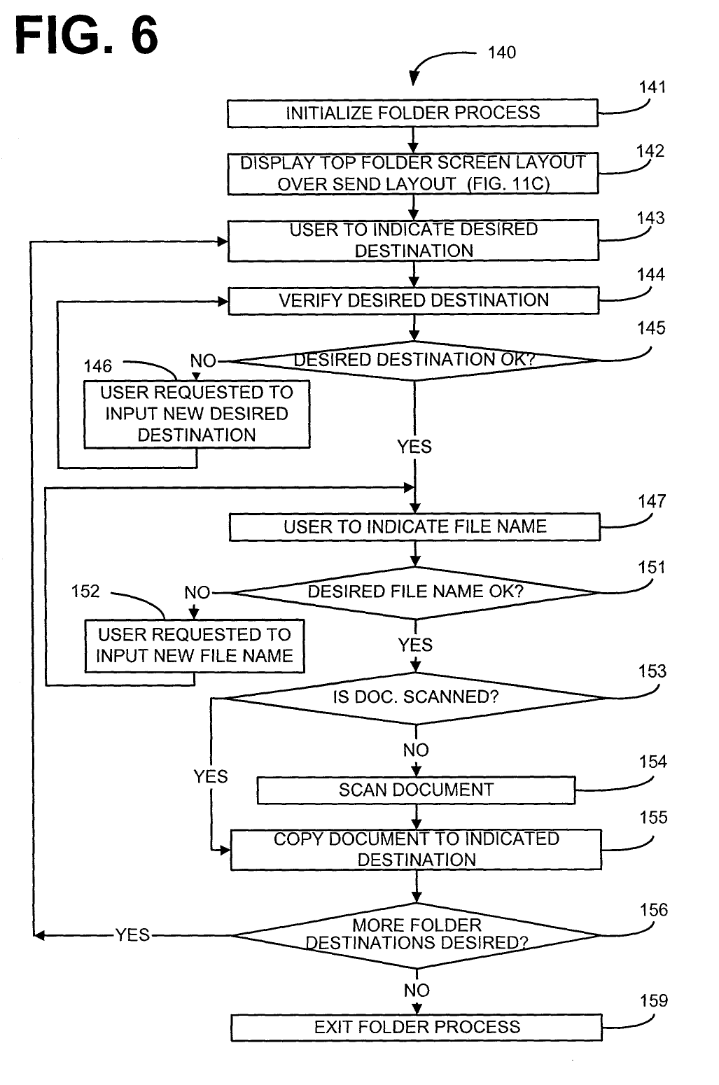

After performing the login process at step 107, or if it is determined at step 106 that login is not required, the send process 100 then determines whether the document scanned is to be sent to a folder at step 111. If it is determined at step 111 that the document is to be sent to a folder, the send process 100 then performs the folder process at step 112. The folder process is herein defined in further detail with regard to FIG. 6.

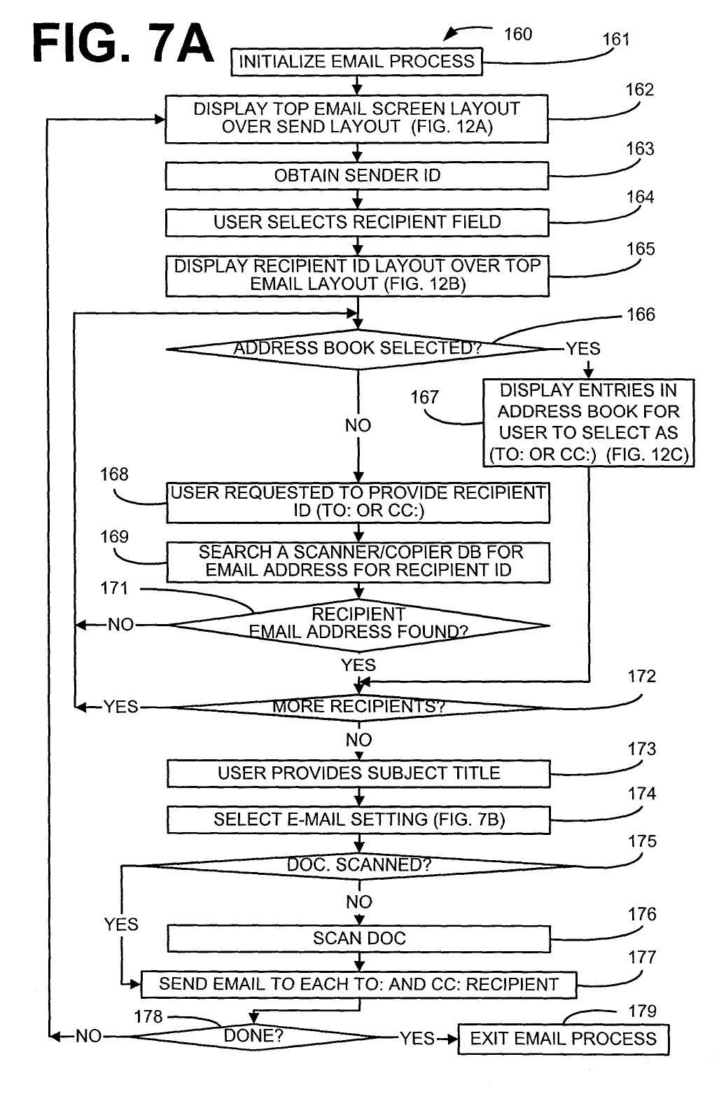

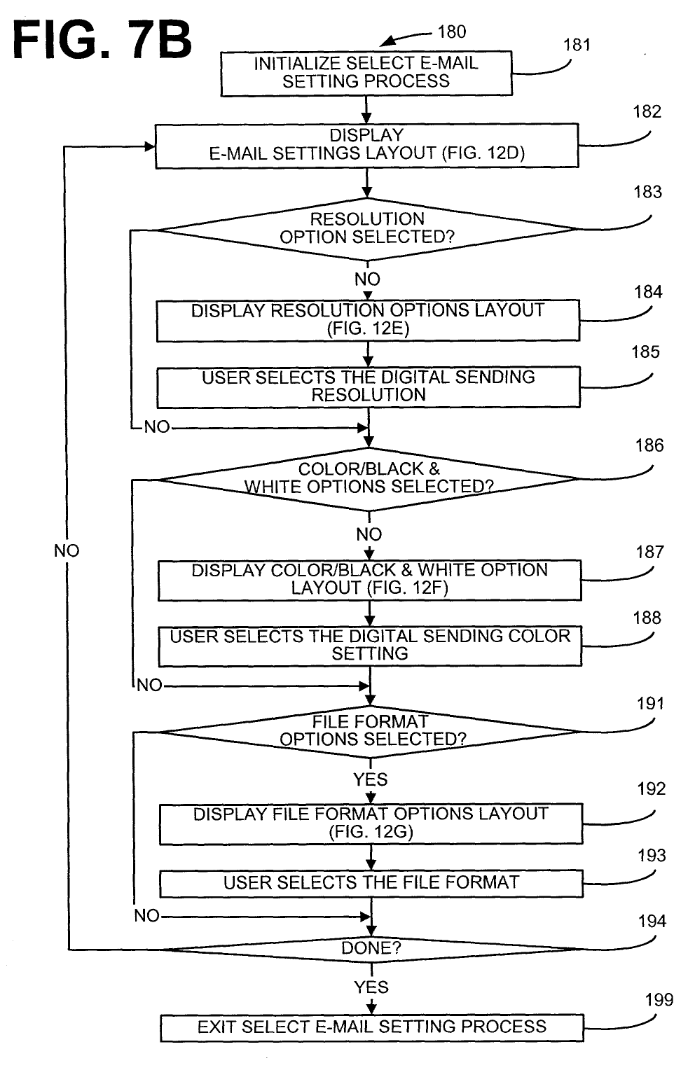

After performing the folder process at step 112, or if it is determined at step 111 that the document is not to be sent to a folder, the send process 100 then determines whether or not the document is to be e-mailed at step 113. If it is determined at step 113 that the document is to be sent via e-mail, the send process 100 then performs the e-mail process at step 114. The e-mail process is herein defined in further detail with regard to FIGS. 7A and 7B.

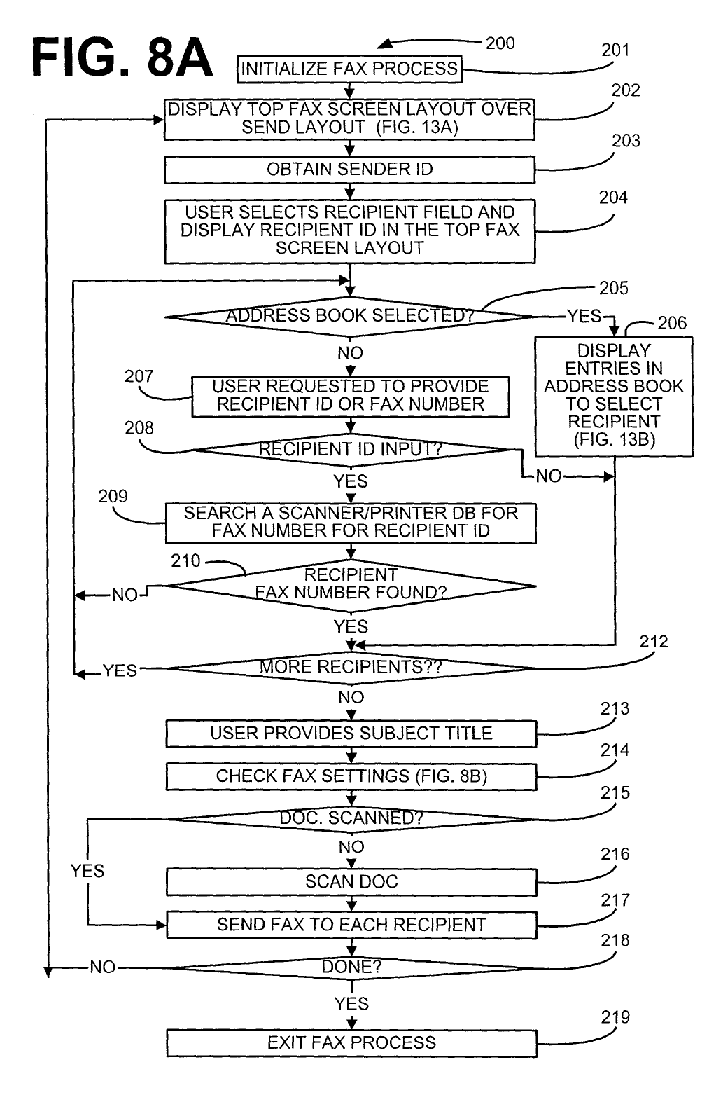

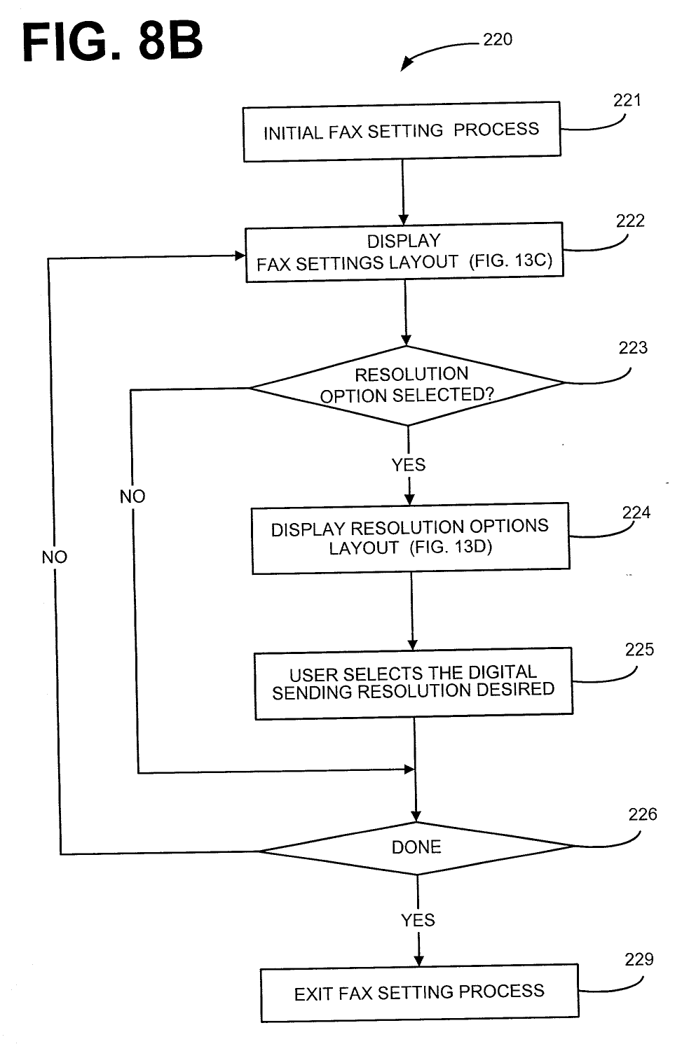

After performing the e-mail process at step 114, or if it is determined at step 113 that the document is not to be e-mailed, the send process 100 then determines whether the document is to be sent by fax at step 115. If it is determined at step 115 that the document is to be sent by fax, the send process 100 then performs the fax process at step 116. The fax process is herein defined in further detail with regard to FIGS. 8A and 8B.

After performing the fax process at step 116, or if it is determined at step 115 that the fax process is not to be performed, the send process 100 then determines whether it is done processing the current document at step 117. If it is determined at step 117 that it is not done sending the current document, the send process 100 then returns to repeat steps 102 through 117. However, if it is determined at step 117 that the send process 100 is done sending the current document, the send process 100 exits at step 119.

Illustrated in FIG. 5 is a flow chart depicting functionality of an example of the login process 120 for the GUI system 80 of the present invention. First, the login process 120 is initialized at step 121. At step 122, the login process 120 displays the top login screen layout over the send layout display. An example of the top login screen layout is illustrated in FIG. 11B. The top login screen layout includes, but is not limited to, user, password, and domain input fields.

At steps 123 and 124, the login process 120 requests the input of the user name and password. At step 125, the login process 120 then acquires a default of the domain name, if available. The domain name can be a system administrator settable default. The login process 120 then displays any available default name at step 126. At step 131, the login process 120 then allows the user to change any default domain name displayed.

After the user has an opportunity to change or input the domain name, the login process 120 then performs an authentication of the login data at step 132. At step 133, the login process 120 determines whether the login data is okay. If it is determined at step 133 that the login data is not okay, the login process 120 then identifies the bad login data at step 134 and requests a change of the bad login data at step 135. An example of the pop-up menu that displays the change of the bad login data is herein displayed in FIG. 11C. In the example, the bad login data pop-up menu is illustrated over a portion of an underlying menu. The login process 120 then returns to repeat steps 132 and 133. However, if it is determined at step 133 that the login data is okay, the login process 120 then exits the login process at step 139.

Illustrated in FIG. 6 is a flow chart depicting functionality of an example of the send to folder process 140. First, the folder process 140 is initialized at step 141. Next, at step 142, the folder process 140 displays a top folder screen layout over the send layout. An example of the top folder screen layout is illustrated in FIG. 11D. The top folder screen layout includes, but is not limited to, the destination folder and the file name to be sent to the destination folder. Next, folder process 140 prompts the user to indicate the desired destination of the file to be sent at step 143.

The folder process 140 then verifies the indicated desired destination, at step 144. At step 145, it is determined whether the desired destination of the document is okay. If it is determined at step 145 that the desired destination of the document is not okay, the folder process 140 then requests the user to input a new desired destination at step 146, and then returns to repeat steps 144 and 145. However, if it is determined at step 145 that the desired destination is okay, the folder process 140 then prompts the user to indicate the file name of the file to be saved, at step 147.

At step 151, the folder process 140 then determines whether the desired file name is okay. If it is determined at step 151 that the desired file name is not okay, the folder process 140 then requests the user to put in a file name at step 152, and then returns to repeat steps 147 and 151. However, if it is determined at step 151 that the desired file name is okay, the folder process 140 then determines whether the document to be sent to the folder is scanned at step 153. If it is determined at step 153 that the document to be sent to the folder is scanned, then the folder process 140 skips to step 155. However, if it is determined at step 153 that the document to be sent to the folder is not scanned, then the folder process 140 scans the document at step 154.

At step 155, the folder process 140 then copies the document to the indicated folder destination, at step 155. At step 156, the folder process 140 then determines whether more folder destinations are desired. If it is determined at step 156 that more folder destinations are desired, the folder process 140 then returns to repeat steps 143 through 156. However, if it is determined at step 156 that there are no more folder destinations desired, the folder process 140 then exits at step 159.

Illustrated in FIG. 7A is a flow chart of an example of the e-mail process 160 utilized by the send process 100 in the GUI system 60 of the present invention. The e-mail process 160 is utilized in the send process 100 of the GUI system 60 of the present invention. The e-mail process 160 enables a user to e-mail a copy of a document.

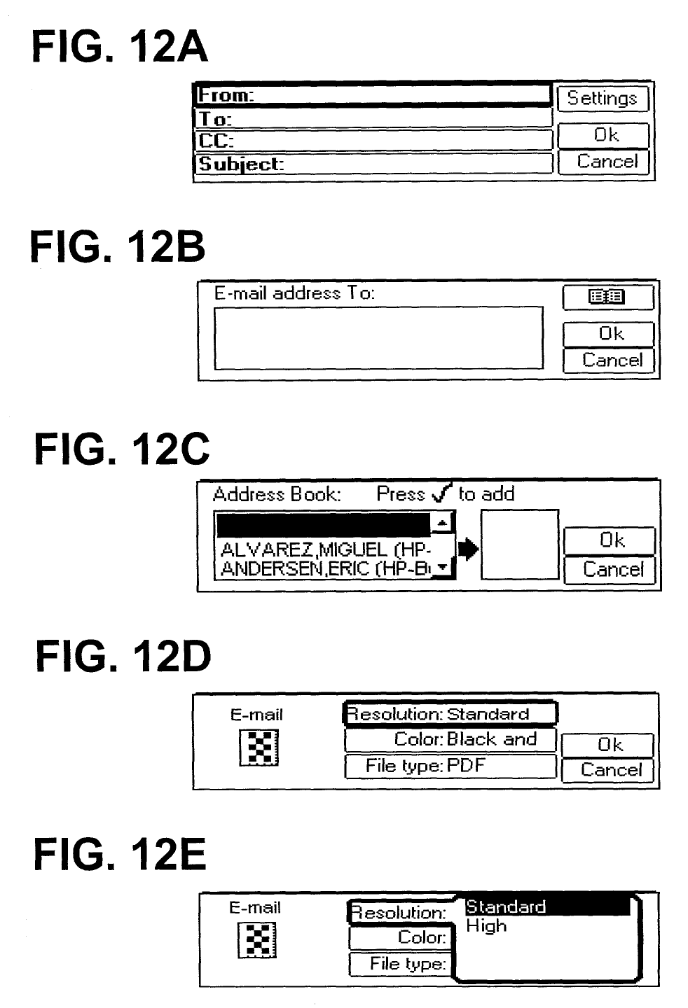

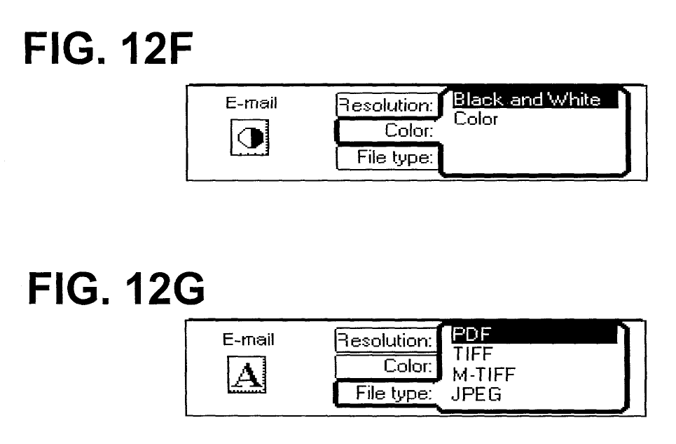

First, the e-mail process 160 is initialized at step 161. Next, the e-mail process 160 displays the top e-mail screen layout over the send layout screen at step 162. An example of the top e-mail screen layout is illustrated in FIG. 12A. This example of an e-mail screen illustrated in FIG. 12A is the first screen to be displayed after the e-mail send option is selected on the send option screen and after authentication is established. Each of the fields “From,” “To,” “CC,” and “Subject” can be selected to open an entry screen where the desired text can be typed in. Selecting any of these functions and beginning to type any character keys will move a user into an entry screen. Also, it is possible to have the “From” field already filled in if either the authentication has been completed or if the “From” value is established by another “Send” destination. Once a user is identified, their e-mail address is filled in automatically. A reset key can clear all the text in the “From,” “To,” “CC,” and “Subject” fields.

At step 163, the e-mail process 160 obtains the sender ID. The user selects the recipient fields at step 164 and the e-mail process 160 displays the recipient ID layout over the top e-mail screen layout at step 165. An example of the recipient ID layout is illustrated in FIG. 12B. The example of the recipient ID layout includes, but is not limited to, a text area to allow for input of the recipient e-mail ID.

At step 166, the e-mail process 160 then determines whether the address book is selected. If it is determined at step 166 that the address book is selected, the e-mail process 160 then displays entry in the address book for the user to select, as the “To” or “CC” recipient as step 167. After allowing the user to select entries from the address book, the e-mail process then proceeds to step 172. An example of the address book layout is illustrated in FIG. 12C. As shown in FIG. 12C, the address book layout includes a listing of potential recipients for receiving the e-mail. The potential recipients are illustrated in this example as being in a table that can be manipulated utilizing scrolling menus, however, it should be known that the inventors contemplate that other types of displaying mechanisms can be used.

However, if it is determined at step 166 that the address book is not selected, the e-mail process 160 then requests the user to provide the recipient ID “To” or “CC’ at step 168. At step 169, the e-mail process 160 then searches a scanner/facsimile/copier database for an e-mail address for the recipient ID. At step 171, the e-mail process 160 then determines whether the recipient e-mail address is found. If it is determined at step 171 that the recipient e-mail was found, the e-mail process 160 proceeds to step 172. However, if it is determined at step 171 that the recipient e-mail address is not found, the e-mail process 160 then returns to repeat steps 166 through 171.

At step 172, the e-mail process 160 then determines whether there are more recipients to receive the e-mail, at step 172. If it is determined at step 172 that there are more recipients to receive the e-mail, the e-mail process 160 then returns to repeat steps 166-172. However, if it is determined at step 172 that there are no more recipients to receive the e-mail, the e-mail process 160 then requests the user to provide a “Subject” title at step 173.

At step 174, the e-mail process 160 allows the user to select the e-mail setting format/color/file. An example of the e-mail setting process is herein defined in further detail with regard to FIG. 7B. At step 175, the e-mail process 160 determines whether the document to be e-mailed is scanned. If it is determined at step 175 that the document to be e-mailed is scanned, the e-mail process 160 then proceeds to step 177 to send the e-mail. However, if it is determined at step 175 that the document to be e-mailed is not scanned, then the e-mail process 160 scans the document at step 176.

At step 177, the e-mail process 160 then sends the e-mail to each “To” and “CC” recipient. At step 178, the e-mail process 160 then determines whether there are more e-mails to be sent. If it is determined at step 178 that there are more e-mails to be sent, the e-mail process 160 then returns to repeat steps 162 through 178. However, if it is determined at step 172 that there are no more e-mails to be sent, the e-mail process 160 then exits at step 179.

Illustrated in FIG. 7B is a flow chart depicting functionality of an example of the e-mail setting process 180 utilized by the e-mail process 160, as shown in FIG. 7A. First, the e-mail setting process 180 is initialized at step 181. At step 182, an e-mail settings layout is displayed. An example of the e-mail settings layout is illustrated in FIG. 12D and is described above.

At step 183, the e-mail setting process 180 then determines whether the resolution option is selected. If it is determined at step 183 that the resolution option is not selected, the e-mail setting process 180 then proceeds to step 186. However, if it is determined at step 183 that the resolution option was selected, the resolution option layout is then displayed at step 184. An example of the pop-up menu that displays the resolution options is illustrated in FIG. 12E. The resolutions options pop-up menu is indicated in FIG. 12E by bold highlight. The resolution options pop-up menu is also displayed as being over a portion of the e-mail screen. At step 185, the user is able to select the digital sending resolution desired.

At step 186, the e-mail setting process 180 determines whether the color or black and white options are selected. If it is determined at step 186 that the color or black and white options are not selected, the e-mail setting process 180 then proceeds to step 191. However, if it is determined at step 186 that the color or black and white options are selected, the e-mail setting process 180 then displays the color or black and white option layout at step 187. An example of the pop-up menu that displays the color or black and white options is illustrated in FIG. 12F. The color or black and white options layout illustrated in FIG. 12F is displayed over a portion of the top e-mail screen layout. The example further illustrates that the color or black and white option layout pop-up menu is within the bold lines. At step 188, the user is then able to select the digital sending color setting desired.

At step 191, the e-mail setting process 180 then determines whether the file format option is selected. If it is determined at step 191 that the file format options is not selected, the e-mail setting process 180 then proceeds to step 194. However, if it is determined at step 191 that the file settings option is selected, the file format options layout is then displayed at step 192. An example of the pop-up menu that displays the file format options is illustrated in FIG. 12G. The file format options layout is depicted as the area within the bold and is displayed over the top screen e-mail layout. The file format option layout selections includes, but are not limited to, .pdf, TIFF, M-TIFF and JPEG type files types. At step 183, the user is permitted to select the desired file format.

At step 194, the e-mail setting process 180 then determines whether the e-mail settings are done. If it is determined at step 194 that the e-mail settings are not done, the e-mail setting process 180 then returns to repeat steps 182 through 194. However, if it is determined at step 194 that the e-mail settings are done, the e-mail setting process 180 then exits at step 191.

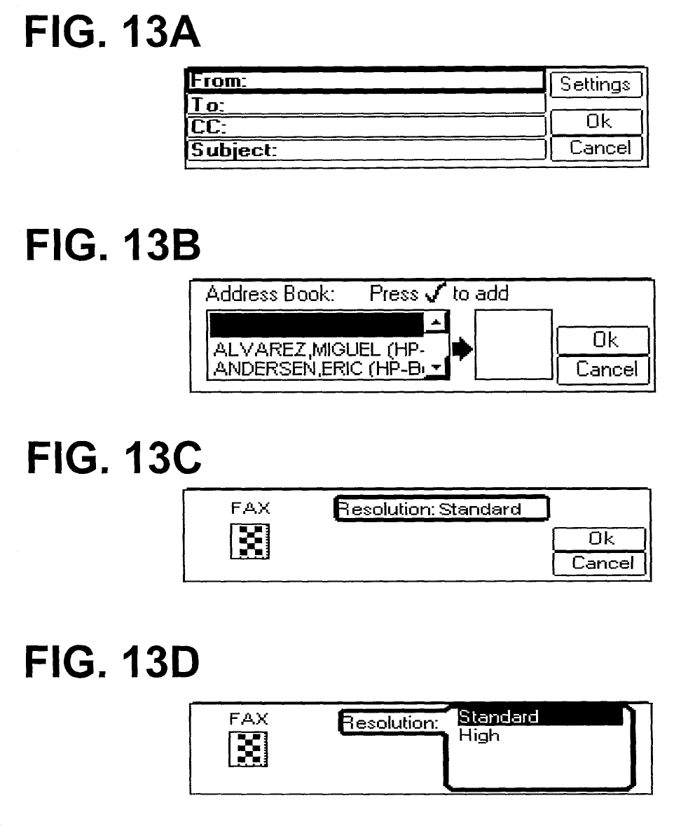

Illustrated in FIG. 8A is a flow chart depicting functionality of an example of the fax process 200. The fax process 200 is utilized in the send process 100 of the GUI system 60 of the present invention. The fax process 200 enables a user to fax a copy of a document. First, the fax process 200 is initialized at step 201. At step 202, the fax process 200 displays the top fax screen layout over the send layout screen. An example of the top fax screen layout is illustrated in FIG. 13A. This example of the top fax screen layout illustrated in FIG. 1 3A is the first screen to be displayed after the fax send option is selected. Each of the fields “from,” “to,” “cc,” and “subject” can be selected to open an entry screen where the desired text can be typed in. Selecting any of these functions and then beginning to type any character keys will move a user into the entry screen. Also, it is possible to have the “from” field already filled in if either the authentication has been completed, or if the “from” value is established by another send destination. Once the user is identified, the fax number is automatically filled in. At step 203, the fax process 200 then obtains a sender ID. At step 204, the fax process 200 then has the user select the recipient field. By selecting the recipient field, the fax process 200 displays a recipient layout screen in the top fax layout screen.

At step 205, the fax process 200 then determines whether the address book is selected. If it is determined at step 205 that the address book is selected, the fax process 200 then displays the entries in an address book for the user to select the recipient and fax number for that recipient, at step 206. An example of the address book layout is illustrated in FIG. 13B. As shown, the address book layout includes, but is not limited to, a listing of potential recipients for receiving the fax. The potential recipients are in a table that can be manipulated utilizing scrolling menus, however, it should be known that the inventors contemplate other types of displaying mechanisms can be used. After allowing the user to select entries in the address book, the fax process 200 then proceeds to step 212 to determine whether there are more recipients.

However, if it is determined at step 205 that the address book is not selected, the fax process 200 then requests the user to provide the recipient ID or fax number at step 207. At step 208, the fax process 200 then determines whether there was recipient ID input. If it is determined at step 208 that the recipient ID was not input, the fax process 200 then skips to step 212 to see whether there are more recipients of the fax. However, if it is determined at step 208 that a recipient ID was input, then the fax process 200 then searches a scanner/printer database for a fax number for the recipient ID input. At step 210, the fax process 200 determines whether the recipient fax number was found. If it is determined at step 210 that the recipient fax number was found, the fax process 200, the fax process 200 proceeds to step 212 to determine whether there are more recipients of the fax. However, if it is determined at step 210 that the recipient fax number was not found, the fax process 200 then returns to repeat steps 205 through 210.

At step 212, the fax process 200 then determines whether there are more recipients of the fax. If it is determined at step 212 that there are more recipients of the fax, the fax process 200 returns to repeat steps 205 through 212. However, if it is determined at step 212 that there are no more recipients of the fax, the fax process 200 then requests the user to provide a subject title, at step 213 and checks the fax settings at step 214. The fax setting process is herein defined in further detail with regard to FIG. 8B.

After checking the fax settings, the fax process 200 then determines at step 215 whether the document to be faxed is scanned. If it is determined at step 215 that the document to be faxed is scanned, then the fax process 200 skips to step 217 to send the fax. However, if it is determined at step 215 that the document to be faxed is not scanned, the fax process 200 then scans the document at step 216. At step 217, the fax process 200 then sends the fax to each recipient identified above.

At step 218, the fax process 200 then determines whether there are more faxes to be sent. If there are more faxes to be sent, the sent fax process 200 then returns to repeat steps 202 through 218. However, if it is determined at step 218 that there are no more faxes to be sent, the fax process 200 then exits at step 219.

Illustrated in FIG. 8B is a flow chart depicting functionality of an example of the fax setting process 220 utilized by the fax process 200, as shown in FIG. 8A. First, the fax setting process 210 is initialized at step 221. At step 222, the fax setting process 220 then displays the fax setting layout. An example of the fax setting layout is illustrated in FIG. 13C. The fax setting layout includes, but is not limited to, fax settings such as the resolution of the fax copy to be sent.

At step 223, the fax setting process 220 then determines whether the resolution option is selected. If it is determined at step 223 that the resolution option is not selected, the fax setting process then proceeds to step 226. However, if it is determined at step 223 that the resolution option is selected, then the fax setting process 220 displays the resolution options at step 224. An example of the pop-up menu that displays the resolution options is illustrated in FIG. 13D. The resolutions options pop-up menu illustrated in FIG. 13D is displayed over a portion of the fax setting layout illustrated in FIG. 13C. The resolution options for fax setting are depicted in the menu within the bold outline and consists of standard and high resolution selections. At step 225, the user is directed to select the digital sending resolution desired.

At step 226, the fax setting process 220 then determines whether there are more fax settings to set. If it is determined at step 226 that there are more fax settings to be set, the fax setting process 220 then returns to repeat steps 222 through 226. However, if it is determined at step 226 that there are no more fax settings to be set, then the fax setting process 220 exits at step 229.

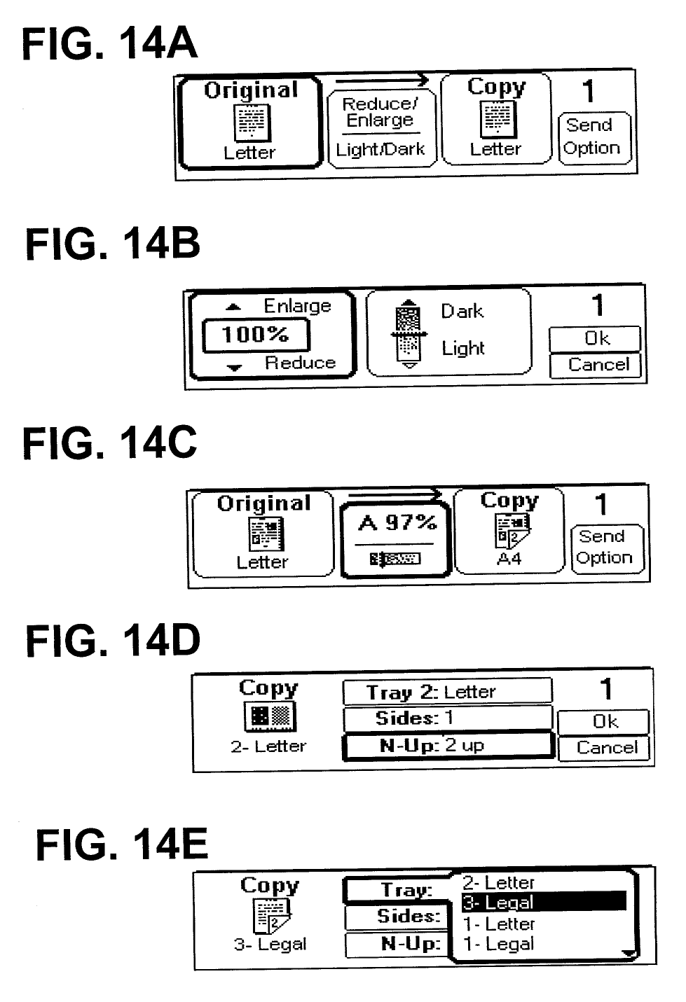

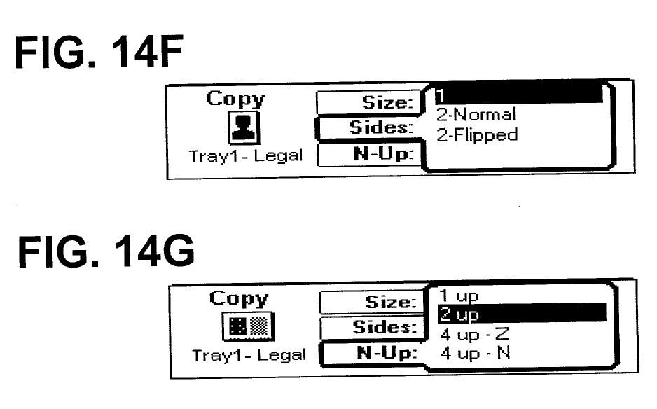

Illustrated in FIG. 9A is a flow chart depicting functionality of an example of the copier process 240 utilized in the GUI system 60 of the present invention. The copier process 240 enables a user to make copies of a desired document. First, the copier process 240 is initialized at step 241. At step 242, the top copier screen layout is displayed. An example of the top copier layout screen is illustrated in FIG. 14A. The example top copier layout screen illustrated in FIG. 14A depicts selections for indicating the original document, scale and contrast options, copy option and send options.

At step 243, the copier process 240 then directs the user to select the desired copier option. At step 244, the copier process 240 determines whether the original option was selected. If it is determined at step 244 that the original option was selected, the copier process 240 then performs the original document setting process 80 (FIG. 3B).

After performing the original document setting process 80 or determining that the original option was not selected, the copier process 240 then determines whether the scale and contrast option is selected at the original document to copy, at step 246. An example scale and contrast layout includes, but is not limited to, the enlarge/reduce and contrast dark/light options. Shown in FIG. 14B is an example illustrating that the scale option is selected and will enable a user to enlarge or reduce the copy document. If it is determined at step 246 that the scale or contrast option was selected, the copier process 240 then displays the scale and contrast layout over the contrast and send buttons at step 247. An example of the scale and contrast layout is illustrated in FIG. 14C. In the example, the copy document setting layout illustrates that the copy is to be 97% scale of the original and that the copy contrast is to be darker than the original. Also illustrated, is that the copy document is to be printed in an A4 size media. At step 248, the copier process 240 then directs the user to define the scale and contrast of the copied document.

After allowing the user to define the scale and contrast of the copier document at step 248 or if it is determined at step 246 that the scale and contrast is not selected, the copier process 240 then determines whether the copy function was selected at step 251. If it is determined at step 251 that the copy was selected, the copier process 240 then performs a copy document setting process at step 252. The copy document setting process is herein defined in further detail with regard to FIG. 9B.

After performing the copy document setting process or if it is determined at step 251 that the copy was not selected, the copier process 240 determines whether there are more selections desired at step 253. If it is determined that there are more selections desired by the user, the copier process 240 then returns to repeat steps 243 through 253. However, if it is determined at step 253 that the user does not desire any more selections, the copier process 240 then determines at step 254 whether the document to be copied is scanned. If it is determined at step 254 that the document to be copied is scanned, then the copier process 240 proceeds to step 256 to copy the document. However, if it is determined at step 254 that the document to be copied is not scanned, then the copier process 240 scans the document at step 255. At step 256, the copier process 240 then copies the document and exits at step 259.

Illustrated in FIG. 9B is a flow chart depicting functionality of an example of the copy document setting process 260 utilized by the copier process 240, as shown in FIG. 9A. The copy document setting process 260 enables the user to select the desired setting for the document to be copied. First, the copy document setting process 260 is initialized at step 261. At step 262, the copy document settings layout is displayed. An example of the copy document settings layout is illustrated in FIG. 14D. The copy document settings layout displayed in FIG. 14D indicates the current settings for the copy document. The copy document settings layout also includes, but is not limited to, options for the user to select in order to customize the copy process. As shown in FIG. 14D, the current copy document is setup to be one-sided and to be out of tray 2, which is letter size paper, The copy document settings layout also includes options for the user to customize the tray selected, the sides of the copy, and copy N-up settings. The N-up settings option allows more than one page image to be displayed on one side of a printed page.

At step 263, the copy document setting process 260 determines whether the copy tray option is selected. If it is determined at step 263 that the copy tray option is not selected, then the copy document setting process 250 proceeds to step 266. However, if it is determined at step 253 that the copy tray option was selected, then the copy document setting process 260 displays the copy tray options layout at step 264. An example of the pop-up menu that displays the copy tray options is illustrated in FIG. 14E. As shown in FIG. 14E, the copy tray options layout is displayed over a portion of the copy document setting layout. The copy tray options are depicted in the bold lines and depict the source tray to be utilized for the copy document. At step 265, the user is directed to select the desired copy tray option.

At step 266, the copy document setting process 260 then determines whether the sides option is selected. If it is determined at step 266 that the sides option is not selected, then the copy document setting process 260 then proceeds to step 271. However, if it is determined at step 266 that the sides option was selected, the copy document setting process 260 then displays the copy sides layout at step 267. An example of the pop-up menu that displays the copy sides options is illustrated in FIG. 14F. The copy sides layout pop-up menu is displayed over a portion of the copy document settings layout and includes the number of sides for the copies to be copied upon. The copy sides options pop-up menu shown in FIG. 14F, is depicted in the bold lines. At step 268, the user is directed to select the copy medium number of sides.

At step 271, the copy document setting process 260 determines whether the number of images per side option is selected. If it is determined at step 271 that the number of images per side option is not selected, then the copy document setting process 260 proceeds to step 274. However, if it determined at step 271 that the number of images per side option is selected, then the copy document setting process 260 displays the copy N-up setting layout at step 272. An example of the pop-up menu that displays the copy N-up setting options is illustrated in FIG. 14G. The copy N-up settings menu is depicted in the bold lines and is displayed over a portion of the copy document settings layout. The N-up settings option allows more than one page image to be displayed on one side of a printed page. At step 263, the user is directed to select the copy N-up setting.

At step 274, the copy document setting process 260 then determines whether there are more copy document settings to be selected. If it is determined that there are more copy document settings to be selected, then the copy document setting process 260 returns to repeat steps 262 through 274. However, if it is determined at step 274 that the copy document settings selection is done, the copy document setting process 260 then exits at step 279.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for disguising the depth of tree menus, said method comprising steps of:
displaying a top menu on a display device;
enabling a user to select an option; and
displaying a second level menu in response to the option selection, wherein the second level menu leaves a portion of the top menu visible to the user.

2. The method of claim 1, wherein the displaying a second level menu step further comprises:
displaying a pop-up box over the portion of the top menu.

3. The method of claim 1, wherein the displaying a second level menu step further comprises:
displaying a plurality of function options.

4. The method of claim 1, further comprising:
indicating the option selected by the user.

5. The method of claim 1, wherein enabling a user to select an option step further comprises the steps of:
using the input device to receive an option selection of the user, wherein the input device is selected from the group consisting of a keyboard, keypad, buttons and a touch screen.

6. A system for disguising the depth of tree menus, comprising:
means for displaying a top menu on a display device;
means for enabling a user to select an option; and
means for displaying a second level menu in response to the option selection, wherein the second level menu leaves a portion of the top menu visible to the user.

7. The system of claim 6, wherein the displaying the second level menu means further comprises:
means for displaying a pop-up box over the portion of the top menu.

8. The system of claim 6, wherein the displaying the second level menu means further comprises:
means for displaying a plurality of function options.

9. The system of claim 6, further comprising:
means for indicating the option selected by the user.

10. The system of claim 9, wherein the enabling the user means further comprises:
an input device means for inputting the desired input of the user, wherein the input device means is selected from the group consisting of a keyboard, keypad, buttons and a touch screen.

11. A computer readable medium for disguising the depth of tree menus, comprising:
logic for displaying a top menu on a display device;
logic for enabling a user to select an option; and
logic for displaying a second level menu in response to the option selection, wherein the second level menu leaves a portion of the top menu visible to the user.

12. The computer readable medium of claim 11, wherein said logic for displaying a second level menu further comprises:
logic for displaying a pop-up box over the portion of the top menu.

13. The computer readable medium of claim 11, wherein said logic for displaying a second level menu further comprises:
logic for displaying a plurality of function options.

14. The computer readable medium of claim 11, further comprising:
logic for indicating the option selected by the user.

15. The computer readable medium of claim 14, wherein said logic for enabling a user to select an option further comprises:
logic for inputting the desired input of the user, wherein the inputting logic is selected from the group consisting of a keyboard logic, keypad logic, button logic and a touch screen logic.

16. A system for disguising the depth of tree menus, comprising:
a display device configured to display a top menu;
an input device configured to enable a user to select an option; and
a graphical user interface that displays a second level menu on the display device in response to the option selection, wherein the second level menu leaves a portion of the top menu visible to the user.

17. The system of claim 16, wherein the graphical user interface further comprises:
graphical user interface that displays a pop-up box over the portion of the top menu on the display device.

18. The system of claim 16, wherein the graphical user interface further comprises:
graphical user interface displays a plurality of function options on the display device.

19. The system of claim 16, further comprising;
an indicator mechanism that indicates the option selected by the user.

20. The system of claim 19, wherein the input device is selected from the group consisting of a keyboard, keypad, buttons and a touch screen.
